(19) United States
(12) Patent Application Publication
(10) Pub. No.: US 2010/0269159 A1
(43) Pub. Date: Oct. 21, 2010

(54) METHOD AND DEVICE FOR OPERATING AN AUDIO AND/OR VIDEOCONFERENCE WITH AT LEAST TWO PARTICIPANTS

(76) Inventor: Norbert Oertel, Landshut (DE)

Correspondence Address: STAAS & HALSEY LLP, SUITE 700, 1201 NEW YORK AVENUE, N.W., WASHINGTON, DC, 20005, US

(21) Appl. No.: 12/810,679

(22) PCT Filed: Dec. 8, 2008
(86) PCT No.: PCT/EP08/67016

§ 371 Date: Jun. 25, 2010

(30) Foreign Application Priority Data
Dec. 27, 2007 (DE) 10 2007 062 734.5

(51) Int. Cl. G06F 15/16; G06F 17/30; G06F 21/20; G06F 3/048

(52) U.S. Cl. 726/4; 715/753; 707/705; 707/E17.001

(57) ABSTRACT

The embodiments relate to a method for operating an audio and/or videoconference having at least two participants. A central computer, which controls the audio and/or videoconference, ascertains an identification datum of the participant initiating the conference. The central computer ascertains, on the basis of the identification datum from at least one database, which is coupled to the central computer, contact data of potential participants of the conference, the contact data being associated with the user. The contact data ascertained by the central computer are provided to the user initiating the conference as further conference participants for selection.

### CROSS REFERENCE TO RELATED APPLICATIONS

This application is the U.S. national stage of International Application No. PCT/EP2008/067016,filed Dec. 8, 2008 and claims the benefit thereof. The International Application claims the benefit of German Application No. 102007062734.5, filed on Dec. 27, 2007, both applications are incorporated by reference herein in their entirety.

### BACKGROUND

1. Field

The embodiments relate to a method for operating an audio and/or videoconference with at least two participants, in which the conference is controlled by a central computer. The embodiments further relate to a computer for controlling an audio and/or videoconference between a number of participants.

2. Description of the Related Art

Such a central computer is also referred to as a Multipoint Control Unit (MCU). Such a computer can for example be provided as a central hub for conferences in a communication network. Media and/or control data streams are received from a number of conference participants via this central computer and, depending on the configuration of the central computer, processed and sent back to the participants participating in the conference. The media data streams can be combined here and sent to all participants. This enables a number of participants to see and/or hear at the same time. In another operating mode only that media DataStream of the participant currently speaking is ever sent to all other participants. Such a central computer typically makes it possible to support conferences with three or more participants. The conference can be executed and managed in accordance with the “tightly coupled and centrally mixed” principle, for example. In this case each of the participants is connected to the central computer, with the central computer terminating the media data streams for each of the participants, mixing them or connecting them to media data streams of the other participants and transmitting a combined media data stream to all participants.

A conference is normally initiated by one participant. The other participants can essentially enter the conference in two different ways: One way which can be used is a dial-in method, in which each participant who would like to take part in the conference dials a code, e.g. a telephone number, of the central computer and contacts the latter. On the other hand dial-out can be used in which the central computer contacts the participants. To this end the respective participant codes are specified to the central computer by the participant initiating the conference, on the basis of which the central computer can contact the participants.

The use of dial-out to add participants to the conference is currently cumbersome since the participant codes (e.g. telephone numbers) of the further conference participants must be entered manually by the participant initiating a conference into their terminal and transmitted to the central computer. Although current central computers provide the option of storing the participant codes notified to the central computer temporarily or permanently to be used again later by this participant, the duration of the storage and the number of possible contact numbers to be stored cannot be influenced by the participant.

### SUMMARY

Aspect of the embodiments are thus to specify a method for operating, especially initiating, an audio and/or videoconference with at least two participants as well as a computer for controlling the audio and/or videoconference of a number of participants which allow a simply use of the dial-out method for adding participants to a conference.

In the subsequent description a participant is to be understood as any given terminal of a person with which this person can participate in an audio and/or videoconference. Such a terminal can for example be a telephone (with video capabilities) or a computer with communication software installed on it.

In the method for operating an audio and/or videoconference with a least two participants, a central computer controlling the audio and/or videoconference determines identification data of the participant initiating the conference. The central computer determines on the basis of the identification data from at least one database linked to the central computer contact data of potential participants of the conference, with the contact data being assigned to this participant (initiating the conference). The contact data determined by the central computer is made available for selection to the participant initiating the conference as further conference participants.

The principle underlying the embodiments thus includes making contacting the further participants of an audio and/or videoconference (general conference) easier in that the participant initiating the conference is provided with contact data assigned to him of further participants for selection. To this end the central computer determines identification data of the initiating participant, i.e. his participant code, in order, on the basis of this identification data, to determine such contact data from one or more databases that the participant initiating the conference has stored in the past or which has been made available centrally. For selection of the further participants of the conference the participant initiating the conference then merely needs to select the relevant contact data made available for selection, e.g. visualized, whereupon the central computer can establish a connection to this participant. This dispenses with the participant initiating the conference having to manually enter participant codes. The fact that databases with contact data which is assigned to respective participants of a communication network are made available to the central computer significantly simplifies the initialization of a conference for a participant.

A Session Initiation Protocol (SIP) address is determined as identification data of the participant initiating the conference in accordance with an expedient embodiment. This makes additional signaling between the participant initiating the conference and the central computer superfluous, since the SIP address is part of the message flow, provided the communication is based on the Session Initiation Protocol (SIP).

To make it possible for the participant initiating the conference to select further participants, the central computer can access a wide diversity of databases. Thus, in accordance with an embodiment, there is provision for the central computer to access a first database of contact data which is assigned to all participants. Such a database typically includes a global address book in a large corporation. As an alternative or in addition, there is provision for the central computer to access a second database of contact data which is assigned exclusively and permanently to the participant initiating the conference. Such a second database typically includes contact data which a respective participant has stored himself and is only accessible to him. Furthermore there can be provision for the central computer to access a third database of contact data which is assigned exclusively and temporarily to the participant initiating the conference. This third database typically includes contact data which was created manually by the participant initiating the conference and has been transmitted to the central computer for processing.

The contact data of the first, the second and the third database can be made available for selection jointly or separately. Making it available jointly means, in this case, that all contact data contained in the different databases is merged by the central computer into a single list and this is typically made available in list form for selection to the participant initiating the conference. Since such a method can, however, be very unclear with a plurality of contact data, this embodiment also includes making the contact data determined from the different databases available in a structured manner. Thus, for example, the contact data of the first database can be made available in a first list, the contact data of the second database in a second list etc. This makes the selection of the further participants of the conference easier for the participant initiating the conference.

In accordance with a further expedient embodiment, there can be provision for an authentication of the participant initiating the conference to be undertaken by the central computer. All methods known from the prior art can be used for this purpose. Such authentication can be provided, for example, during an exchange of data between the central computer and the participant initiating the conference in a simple manner, e.g. by using IPsec, TLS (Transport Layer Security) or S/MIME (Secure/Multipurpose Internet Mail Extensions). Over and above this, challenge-response requests or PIN requests have now come into use. Security mechanisms can also be used which serve to verify the message integrity and/or confidentiality.

In order to further improve the manageability of the method, there is provision for transmission of the contact data determined by the central computer in media data structure by the central computer to the participant (initiating the conference). A media data stream can include audio data or video data, depending on the conference. If the contact data determined is transmitted in the media data stream from the central computer to the participant, this results in the contact data being mixed with the contact data, so that the contact data is presented, for example, overlaid over the contact data. Independent thereof the embodiments also include the option of transmitting the contact data determined separately from the media data, e.g. as part of a control data stream which is exchanged between the central computer and the participant initiating the conference.

In accordance with a further embodiment of the method a file with contact data of another participant is transmitted by the participant initiating the conference to the central computer which stores the contact data especially in a third database and/or adds the participant identified on the basis of the contact data of the file to the conference or vice versa. This procedure is sensible if the participant initiating the conference is not situated within a communication network, so that an authentication of the participant is not possible. This is the case, for example, if the participant initiating the conference connects to the central computer using a dial-in connection. In this way, it is still possible for the participant initiating the conference to use contact data from a database accessible to him personally and to transmit this data in the form of a file to the central computer for further processing. The further processing can include, on the one hand, of storage of the contact data and, on the other hand, of the inclusion of the participants represented by the contact data to the conference.

The file can be transmitted using an SIP INFO message. Expediently, the file contains the contact data in ASCII format, for example in the form of a vCard. As an alternative to SIP INFO, other protocols can also be employed, such as a negotiated media stream for transmission of media data for example, the “SIP event package” but also other mechanisms in alternate signaling protocols, such as H.323 for example.

In accordance with a further embodiment contact data which is stored in a database assigned to a specific participant of the conference is additionally stored by the central computer in the respective database assigned to one or more other participants of the conference. This procedure is especially useful if the participant initiating the conference transmits one or more files with contact data of another participant to the central computer. In this way, it is possible to also provide other participants of the conference with the contact data stored in the file all the files by storing these in respective databases which are assigned to the participants concerned.

The embodiments also include a computer program product which can be loaded directly into the internal memory of a digital computer and software code sections with which the operations of the method are executed when the product runs on a computer. The computer program product can, for example, be available in the form of a CD, a DVD, a diskette and the like. The computer program can also be available in the form of a computer signal which is transmitted over a computer network.

A computer for controlling and audio and/or videoconference of a number of participants includes a first mechanism for determining identification data of a participant initiating the conference. It further includes a second mechanism for reading out contact data of potential participants of the conference, with the contact data being assigned to this subscriber, from at least one database linked to the central computer. A third mechanism is provided with which the contact data can be made available for selection to the participant initiating the conference as further conference participants. This has the same advantages associated with it as have been explained above in connection with the method.

In accordance with an expedient embodiment the third mechanism is embodied for transmitting the contact data determined in a media DataStream to the participant.

In accordance with a further embodiment the computer comprises a fourth mechanism for authenticating the participant initiating the conference.

In accordance with a further embodiment the computer is embodied for storing a message transmitted by the participant initiating the conference with contact data of another participant in the least one database and/or adding the participant identified on the basis of the contact data of the file to the conference or vice versa.

### BRIEF DESCRIPTION OF THE DRAWINGS

These and other aspects and advantages will become more apparent and more readily appreciated from the following description of the exemplary embodiments, taken in conjunction with the accompanying drawing of which:

FIG. 1 shows a schematic diagram of a communication network with a computer for controlling an audio and/or videoconference.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

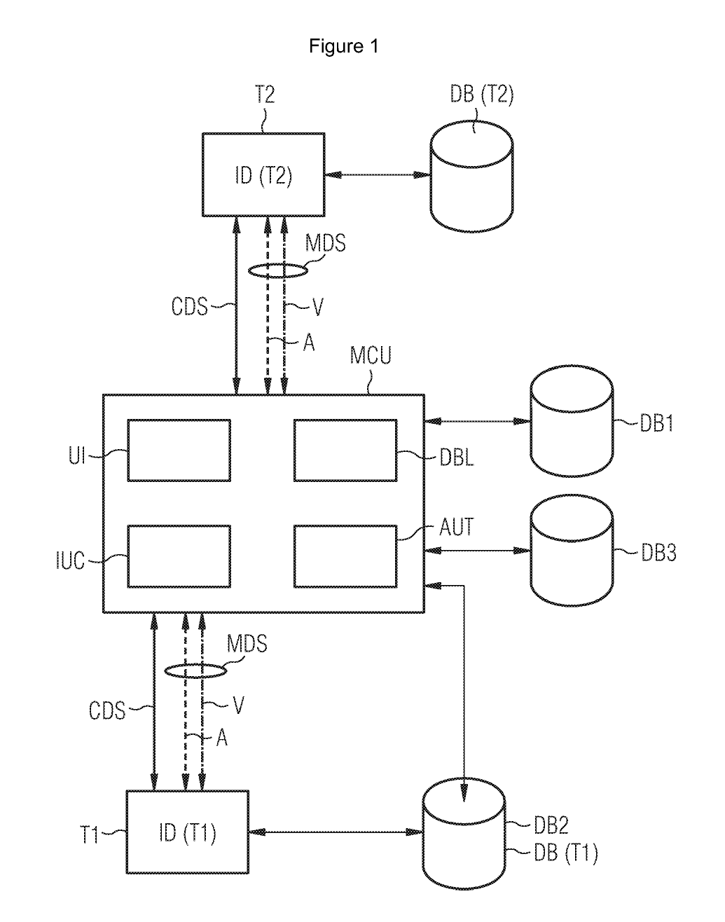

For executing and controlling and audio and/or videoconference, a central computer MCU (FIG. 1) is provided, which in the exemplary embodiment is arranged centrally between typically two participants T1 and T2 for controlling the conference. The embodiments are therefore described with reference to a star-shaped topology in which the central computer MCU is realized as the central hub. Such a topology is referred to as “tightly coupled, centrally mixed”. The embodiments can, however, also be realized with other topologies in which likewise a central computer MCU controlling the conference is provided. The topologies “tightly coupled, fully meshed” or “multicast media and session” can be involved, by way of example.

In the description below the participant T1 represents the participant initiating the conference while participant T2 is a participant to be added to the conference. Each of the participants T1, T2 is assigned identification data ID(T1) or ID(T2) respectively on the basis of which the participant concerned is able to be uniquely identified. The identification data ID(T1), ID(T2) can, for example, be represented by an SIP address. The identification data can, however, also be represented by any other unique participant identification, such as a participant number, a telephone number and the like for example.

In FIG. 1 each of the participants T1, T2 is assigned a database DB(T1) or DB(T2) in which contact data is stored in each case by the participant concerned T1 and T2. Such contact data typically includes names, addresses, telephone numbers etc. The databases DB(T1) and DB(T2) can, for example, be integrated into the terminal of the participant T1, T2 but can also be stored on a central database memory which can only be accessed by the respective participant T1, T2.

Control data and media data are exchanged between one of the respective participants T1, T2 and the central computer MCU. In FIG. 1, a control data stream is labeled CDS and a media DataStream MDS. The media data stream MDS includes audio data A and video data V. Depending on the conference to be held, exclusively audio data or combined audio and video data can be transferred.

The central computer MCU is connected to two databases DB1 and DB3. Database DB1 represents a first database with contact state which includes all (potential) participants in a communication network. The first database DB1 can, for example, represent a global address book of a corporation. The database DB3, which is also referred to as the third database, has contact data written into it and is administered by the central computer MCU. Thus, the central computer MCU typically adds contact data of the participant T1 initiating the conference to the database DB3 which was created manually by the participant T1 or by using a file with contact data which was transmitted to it. Such a file can typically be transmitted to the central computer MCU using an SIP INFO message. The file can be available, for example, in the form of a vCard. For carrying out the method there is also provision for the central computer MCU to be able to access the databases DB(T1) or DB(T2) assigned to the participants T1 or T2. Such access is, however, only necessary to the database of the participant initiating the conference which is why in FIG. 1 only a connection to the database of participant T1 is depicted. This database, provided with private data of the participant T1, represents a second database DB2 from the standpoint of the central computer MCU.

The method for initiating the audio and/or videoconference will be described below. To initiate the conference, data is exchanged between the participant T1 and the central computer MCU, which for example is done using messages in accordance with the SIP protocol (SIP messages). As part of the exchange of the SIP messages, in the present exemplary embodiment, the SIP address of the participant T1 which represents its identification data, is transmitted. This is determined by a first unit or process UI of the central computer MCU. On the basis of the SIP address, the second unit or process DBL is able to identify contact data assigned to the participant T1 in the databases DB1, DB2 and DB3. This data is retrieved by the unit DBL from the databases DB1, DB2, DB3 and overlaid by a third unit or process IUC, which is responsible for the visualization of the MCU functionality and its status, on to the media data stream MDS, which is transmitted to the participant T1. This puts the participant T1 in a position to selectively choose the contact data now made available to let and thereby to select the conference participants.

The contact data stored in the respective databases DB1, DB2 and DB3 and assigned to the participant T1 can be made available by the unit or process IUC to the participant T1 in its entirety, e.g. in a continuous list. However the contact data determined by the second unit or process DBL can also be made available to the participant T1 in a structured manner, e.g. hierarchically subdivided or in the form of separate lists. Once the participant T1 has selected the participant or participants of the conference these contacted by the central computer MCU, so that thereafter a media DataStream can be exchanged between the participant or the participants under the control of the central computer MCU.

The central computer MCU can further include an optional unit or process AUC for authenticating the participant T1. The authentication can be undertaken within the framework of the exchange of the SIP messages with the contact data assigned to the participant T1 only being made available if the authentication was successful. Mechanisms for carrying out an authentication are sufficiently known from the prior art with in principle any given mechanisms being able to be used.

The contact data assigned to the participant T1 on the basis of its identification data from the databases DB1, DB2 and DB3 can for example be determined using the LDAP (Lightweight Directory Access Protocol) interface.

If a file is transmitted by the participant T1 to the central computer MCU, e.g. using an SIP INFO message which contains contact data, this contact data can be extracted from the file and (temporarily) stored for later use by participant T1 in the third database DB3. This especially makes it possible for participants that cannot be authenticated, e.g. because they are arranged outside a closed network, to use contact data from their personal address book (the database DB(T1)). This method is also available to authenticated participants. There can further be provision for contact data which was transferred by a file to the central computer to be made available to all conference participants. For this purpose the contact data can be stored temporarily in one or more third databases and assigned to the conference participants in each case.

The embodiments especially make it possible to execute videoconferences using a central computer with the option of providing the participants with a simple initiation of conference. In this case, the participant initiating the conference is allowed to access both his personal contact data and also global contact data with the determination of the relevant contact data being taken over by the central computer. This improves usability and simplicity for the participants. Taking account of SIP INFO messages or other protocols to support the exchange of contact date, e.g. via ASCII files, further simplifies the exchange of contact data between conference participants.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-17. (canceled)

18. A method for operating an audio and/or videoconference with at least two participants, comprising:
controlling, by a central computer, the audio and/or videoconference and determining identification data of a participant initiating the conference;
determining, by the central computer, on the basis of the identification data from at least one database linked to the central computer, contact data of potential participants of the conference, with the contact data being assigned to the participant; and
making the contact data, determined by the central computer, available for selection to the participant initiating the conference as further conference participants.

19. The method as claimed in claim 18, wherein an SIP address is determined as identification data of the participant initiating the conference.

20. The method as claimed in claim 18, wherein the central computer accesses a first database with contact data which is assigned to all participants.

21. The method as claimed in claim 18, wherein the central computer accesses a second database with contact data which is assigned exclusively and permanently to the participant initiating the conference.

22. The method as claimed in claim 18, wherein the central computer accesses a third database) with contact data which is assigned exclusively and temporarily to the participant initiating the conference.

23. The method as claimed in claim 20, wherein the contact data of the first, the second and the third database is made available for selection jointly or separately.

24. The method as claimed in claim 18, wherein an authentication of the participant initiating the conference is undertaken by the central computer.

25. The method as claimed in claim 18, wherein contact data determined by the central computer is transferred in a media DataStream from the central computer to the participant.

26. The method as claimed in claim 18, wherein a file with contact data of another participant is transferred by the participant initiating the conference to the central computer which stores the contact data, in the third database and/or adds the participants identified on the basis of the contact data of the file to the conference or vice versa.

27. The method as claimed in claim 26, wherein the file is transmitted using an SIP INFO message.

28. The method as claimed in claim 26, wherein the file contains the contact data in ASCII format.

29. The method as claimed in claim 18, wherein contact data which is stored in a database assigned to a specific participant of the conference is additionally stored by the central computer in a respective database which is assigned to one or more other participants at the conference.

30. A non-transitory computer readable media which can be loaded directly into an internal memory of a digital computer and comprises software code sections with which the method in accordance with claim 18 is performed when the product is run on a computer.

31. A system for controlling an audio and/or videoconference of a number of participants, comprising:
a computer comprising:
first means for determining identification data of a participant initiating the conference;
second means for reading out contact data of potential participants of the conference with contact data being assigned to the participant from at least one database linked to the central computer; and
third means, for making the contact data available for selection to the participant initiating the conference as further conference participants.

32. The computer as claimed in claim 31, wherein the third means transmits the determined contact data in a media data stream to the participant.

33. The computer as claimed in claim 31, further comprising fourth means for authenticating the participant initiating the conference.

34. The computer as claimed in claim 31, wherein the computer stores a file transferred by the participant initiating the conference with contact data of another participant in the at least one database and/or, and the participant identified on the basis of the contact data of the file into the conference or vice versa.

35. A system for controlling an audio and/or video conference of a number of participants, comprising:
at least one database;
a first terminal associated with a first participant;
one or more second terminals associated with one or more second participants; and
a computer, linked to the database, the first terminal and the one or more second terminals, determining identification data of the first participant initiating the conference, reading out contact data of potential ones of the second participants of the conference with contact data being assigned to the first participant from the at least one database linked to the central computer, and making the contact data available for selection to the first participant initiating the conference as further conference participants.
